(19) United States
(12) Patent Application Publication
(10) Pub. No.: US 2010/0165155 A1
(43) Pub. Date: Jul. 1, 2010

(54) CAMERA MODULE WITH PLURAL IMAGING UNITS

(75) Inventor: JEN-TSORNG CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng,Taipei Hsien (TW)

(21) Appl. No.: 12/547,684

(22) Filed: Aug. 26, 2009

(30) Foreign Application Priority Data
Dec. 27, 2008 (CN) 200810306571.2

(51) Int. Cl. H04N 5/225

(52) U.S. Cl. 348/262; 348/E05.024

(57) ABSTRACT

An exemplary camera module includes a base, a number of image sensors and a number of lens modules. The base includes a bottom surface and a number of sloping surfaces sloped relative to the bottom surface. The sloping surfaces are oriented in different planes from each other. The image sensors are positioned on the sloping surfaces, respectively. The lens modules are positioned on the respective sloping surfaces above the respective image sensors.

### BACKGROUND

1. Technical Field

The present disclosure relates to camera modules, and particularly, to a camera module having a number of image units which are positioned noncoplanarly relative to each other.

2. Description of Related Art

Lens modules and image sensors are key components of camera modules. A lens module and an image sensor cooperatively form an imaging unit. A lens module may include a number of lenses and lens holding members. The lens module and image sensor of a typical camera module can only capture images of an object from a position outside of the object at a single moment in time, with the viewed images being constructed within a plane. That is, such camera module is limited to providing conventional two-dimensional (2D) viewed images. As such, the camera module cannot provide three-dimensional (3D) images, panoramic images, or high speed images.

What is needed, therefore, is a camera module which can overcome the above-described shortcomings.

### BRIEF DESCRIPTION OF THE DRAWINGS

Many aspects of the present camera module can be better understood with reference to the following drawings. The components in the drawings are not necessarily drawn to scale, the emphasis instead being placed upon clearly illustrating the principles of the present camera module. Moreover, in the drawings, like reference numerals designate corresponding parts throughout the several views.

FIG. 1 is a schematic, isometric view of a camera module in accordance with a first embodiment.

FIG. 2 is a cross-sectional view of the camera module of FIG. 1, taken along line II-II thereof.

FIG. 3 is a schematic, isometric view of a camera module in accordance with a second embodiment.

FIG. 4 is a cross-sectional view of the camera module of FIG. 3, taken along line IV-IV thereof.

FIG. 5 is a schematic, isometric view of a camera module in accordance with a third embodiment.

### DETAILED DESCRIPTION OF EMBODIMENTS

Various embodiments of the present camera module will now be described in detail below and with reference to the drawings.

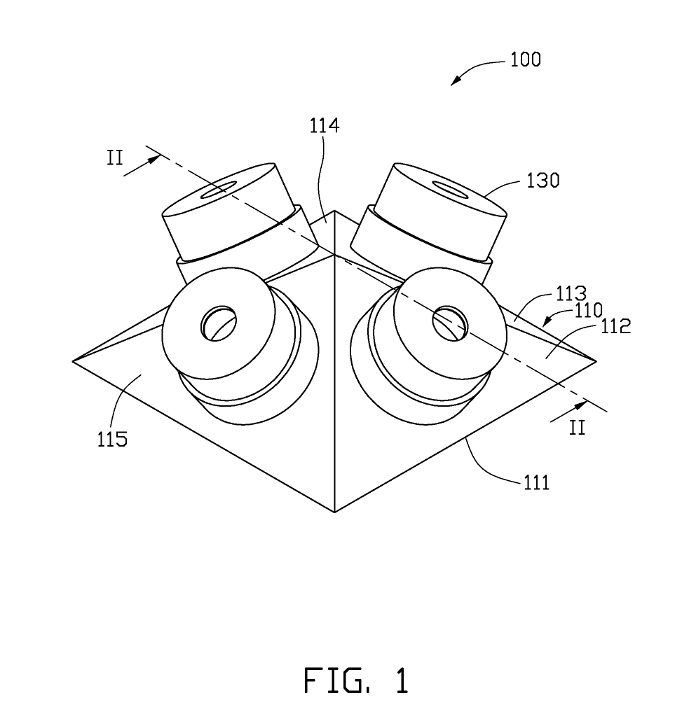

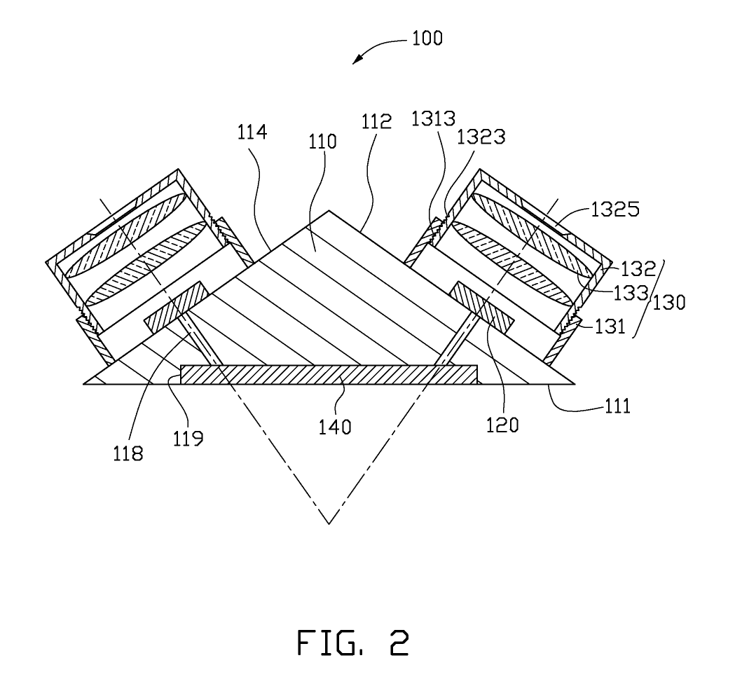

Referring to FIGS. 1 and 2, an exemplary camera module 100 in accordance with a first embodiment is shown. The camera module 100 includes a base 110, a number of image sensors 120, a number of lens modules 130, and an image processor 140.

The base 110 includes a flat bottom surface 111, and four sloping surfaces 112, 113, 114, 115. The sloping surfaces 112, 113, 114, 115 are all flat, and are all oriented in different planes from one another. An angle between each of the sloping surfaces 112, 113, 114, 115 and the bottom surface 111 is an acute angle. In the present embodiment, the four sloping surfaces 112, 113, 114, 115 intersect at a point (apex). The four sloping surfaces 112, 113, 114, 115 and the bottom surface 111 cooperatively form a rectangular pyramid. The four sloping surfaces 112, 113, 114, 115 are top surfaces of the rectangular pyramid. Each two adjacent of the sloping surfaces 112, 113, 114, 115 intersect at a line. The angles between the bottom surface 111 and the respective sloping surfaces 112, 113, 114, 115 are the same. Four through holes 118 are formed in the base 110, between the respective sloping surfaces 112, 113, 114, 115 and the bottom surface 111. A recess 119 is formed in the bottom surface 111, and the recess 119 is in communication with all the through holes 118.

In the present embodiment, there are four image sensors 120. The image sensors 120 are positioned on the respective sloping surfaces 112, 113, 114, 115, and are oriented substantially parallel to the respective sloping surfaces 112, 113, 114, 115. In the present embodiment, there are four lens modules 130, which are positioned on the respective sloping surfaces 112, 113, 114, 115 over the respective image sensors 120. The image sensors 120 are configured for receiving light from the respective lens modules 130 and converting the light into electronic image signals.

Each of the lens modules 130 includes a holder 131, a barrel 132, and a plurality of lenses 133 received in the barrel 132. The holders 131 are mounted on the respective sloping surfaces 112, 113, 114, 115, and each holder 131 includes an inner thread 1313. The barrels 132 each include an incident light aperture 1325 and an outer thread 1323. The barrels 132 are threadedly engaged in the respective holders 131. Central optical axes (see two dashed lines in FIG. 2) of the lens modules 130 are perpendicular to the respective sloping surfaces 112, 113, 114, 115. In the present embodiment, the central optical axes of all the lens modules 130 intersect at a point below the bottom surface 111. In the present embodiment, all the lens modules 130 have the same structure (configuration). In other embodiments, any two or more of the lens modules 130 may have different configurations.

The image processor 140 is received in the recess 116, and is electrically connected to image sensors 120. The image processor 140 is configured for processing image signals received from the image sensors 120, and thus producing an image corresponding to the image signals. Due to the sloping surfaces 112, 113, 114, 115 being oriented in different planes, the lens modules 130 face different directions and can capture images of an object from different positions outside of the object. The imaging units each including one of the lens module 130 and the corresponding image sensor 120 can work at the same time, or work consecutively. In this way, the camera module 100 can capture and provide panoramic images, and high speed images can be obtained.

In another aspect, the base 110 can be regarded as a body which has a number of sloping portions, with each of the sloping portions having a sloping surface 112, 113, 114 or 115.

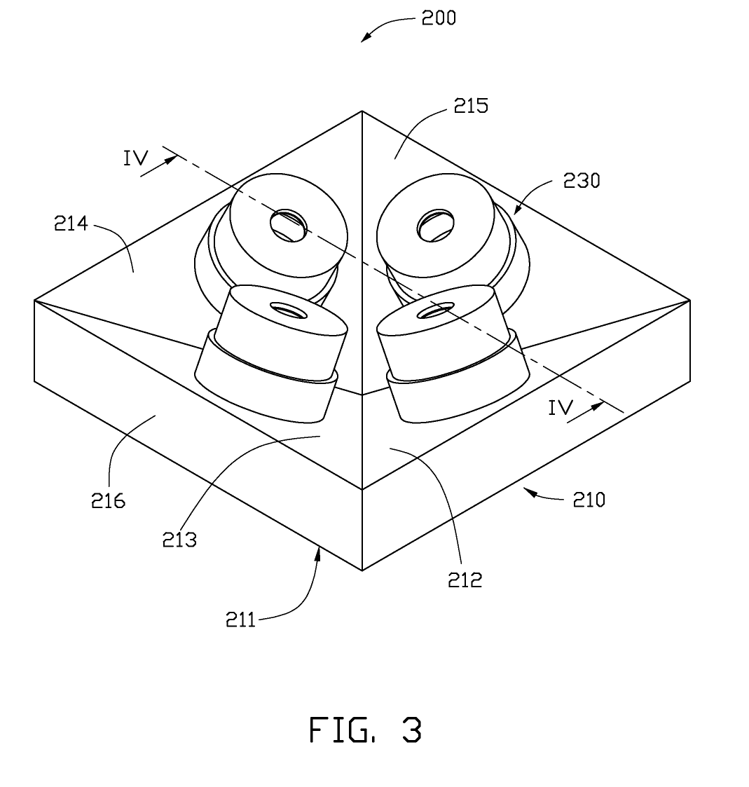

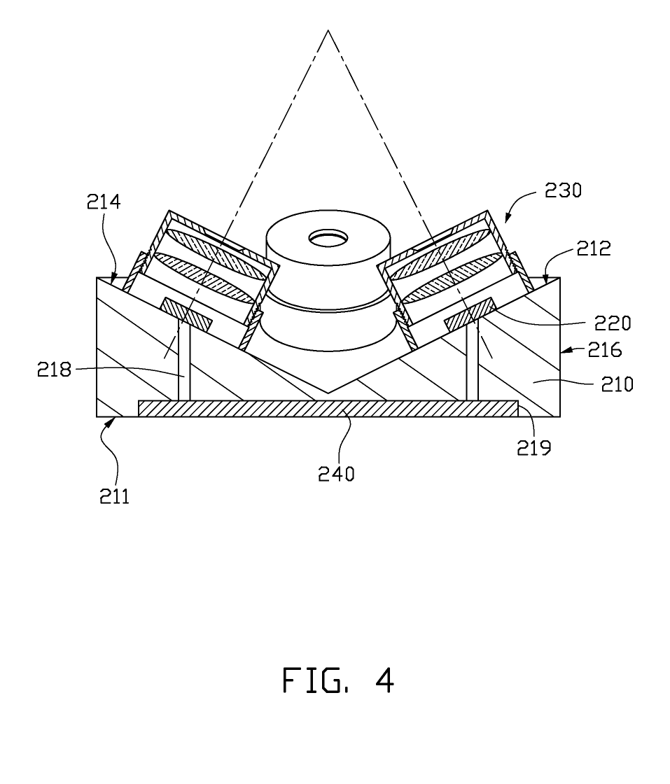

Referring to FIGS. 3 and 4, an exemplary camera module 200 in accordance with a second embodiment is shown. The camera module 200 is similar in principle to the camera module 100 described above. However, a base 210 has a bottom surface 211 and four rectangular side surfaces 216. Thus the base 210 has a substantially rectangular side profile. The base 210 also has four flat sloping top surfaces 212, 213, 214, 215, which cooperatively form a recess. Central optical axes (see two dashed lines in FIG. 4) of four lens modules 230 intersect at a point above the flat sloping top surfaces 212, 213, 214, 215. An image processor 240 is received in a recess 219 of the bottom surface 211, and is electrically connected to four image sensors 220 by four respective through holes 218.

In another aspect, the base 210 can also be regarded as a body which has a number of sloping portions, with each of the sloping portions having a flat sloping top surface 212, 213, 214, or 215.

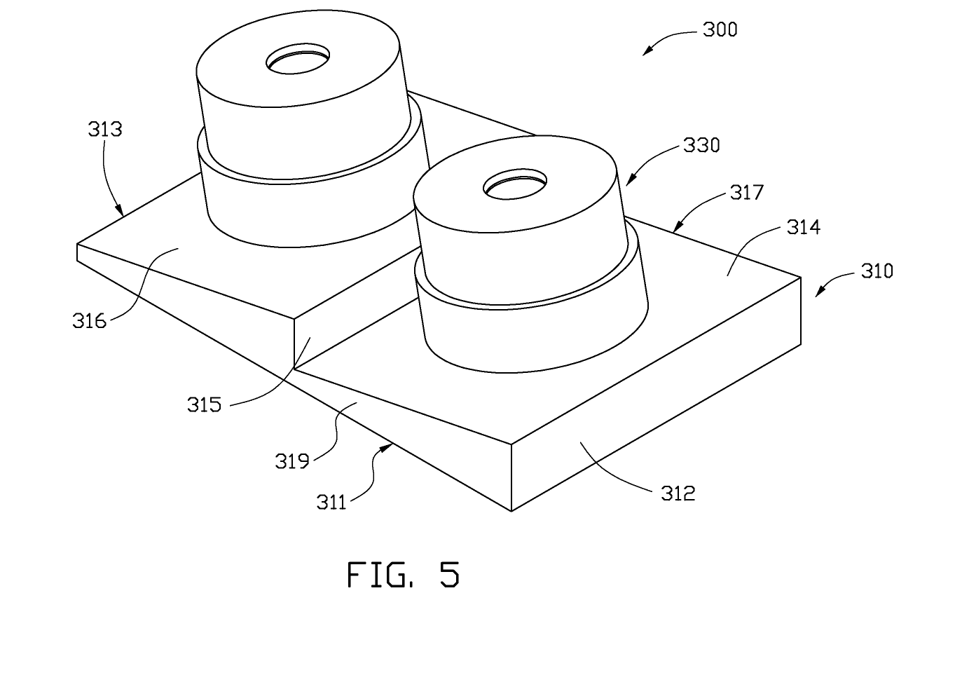

Referring to FIG. 5, an exemplary camera module 300 in accordance with a third embodiment is shown. In the camera module 300, the base 310 is substantially rectangular, and has a flat bottom surface 311 and four side surfaces 312, 313, 317, 319. A step 315 is formed between two adjacent sloping surfaces 314, 316. In the present embodiment, the sloping surfaces 314, 316 are noncoplanar, but are parallel to each other. Two lens modules 330 and two image sensors (not visible) are mounted on the sloping surfaces 314, 316, respectively. An image processor (not visible) is mounted at the bottom surface 311 of the base 310, and is electrically connected to the image sensors by two through holes (not visible) formed in the base 310. The image processor can process image signals received from the image sensors and produce corresponding 3D images.

It is understood that the above-described embodiments are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. A camera module, comprising:
a base comprising a bottom surface and a plurality of sloping surfaces sloped relative to the bottom surface, the sloping surfaces being oriented in different planes from each other;
a plurality of image sensors positioned on the sloping surfaces, respectively; and
a plurality of lens modules positioned on the respective sloping surfaces above the respective image sensors.

2. The camera module as described in claim 1, wherein the image sensors are oriented substantially parallel to the respective sloping surfaces, and central optical axes of the lens modules are substantially perpendicular to the respective sloping surfaces.

3. The camera module as described in claim 1, wherein each of the lens modules comprises a holder mounted on the respective sloping surface, a barrel threadedly engaged with the holder, and a plurality of lenses received in the barrel.

4. The camera module as described in claim 1, wherein the bottom surface is a flat surface, and an angle between each of the sloping surfaces and the bottom surface is an acute angle.

5. The camera module as described in claim 1, wherein the sloping surfaces intersect at a point, and angles between the bottom surface and the respective sloping surfaces are the same.

6. The camera module as described in claim 4, wherein the sloping surfaces and the bottom surface cooperatively form a rectangular pyramid, the sloping surfaces are flat top surfaces of the rectangular pyramid, and central optical axes of the lens modules intersect at a point below the bottom surface.

7. The camera module as described in claim 4, wherein the sloping surfaces cooperatively form a recess having a plurality of planar faces, and central optical axes of lens modules intersect at a point above the sloping surfaces.

8. The camera module as described in claim 1, wherein a step is formed between two adjacent of the sloping surfaces.

9. The camera module as described in claim 8, wherein the sloping surfaces are parallel to each other.

10. The camera module as described in claim 1, wherein two adjacent of the sloping surfaces intersect at a line.

11. The camera module as described in claim 1, further comprising an image processor, the base further comprising a plurality of through holes formed therein, and a recess formed in the bottom surface, the through holes being in communication with the recess, the image processor being received in the recess, and the image sensors being electrically connected to the image processor through the respective through holes.

12. The camera module as described in claim 1, wherein all the lens modules have the same structure.

13. A camera module, comprising:
a base comprising a flat bottom and a plurality of sloping portions each having a flat sloping top surface, the flat sloping top surfaces all being noncoplanar relative to each other;
a recess formed in the flat bottom;
a plurality of through holes formed in the respective sloping portions and being in communication with the recess;
a plurality of image sensors positioned on the flat sloping top surfaces, respectively;
a plurality of lens modules positioned on the respective flat sloping top surfaces above the respective image sensors; and
an image processor mounted in the recess, the image sensors being electrically connected to the image processor through the through holes, respectively.

14. The camera module as described in claim 13, wherein a central optical axis of each of the lens modules is substantially perpendicular to the flat sloping top surface of the corresponding sloping portion, and each of the image sensors is oriented substantially parallel to the corresponding flat sloping top surface.

15. The camera module as described in claim 14, wherein the flat sloping top surfaces intersect at a point.

16. The camera module as described in claim 14, wherein two adjacent of the flat sloping top surfaces intersect at a line.

17. A camera module, comprising:
a base defining a plurality of faces oriented in different planes from each other;
a same plurality of image sensors mounted on the faces of the base, respectively; and
a same plurality of lens modules mounted on the faces of the base above the image sensors, respectively, the lens modules and their corresponding image sensors being configured for capturing images of a same object from their different positions outside of the object.

18. The camera module as described in claim 17, wherein the base comprises a bottom surface, and the plurality of faces are sloped relative to the bottom surface.

19. The camera module as described in claim 17, further comprising an image processor, the base further comprising a plurality of through holes formed therein, and a recess formed in the bottom surface, the through holes being in communication with the recess, the image processor being received in the recess, and the image sensors being electrically connected to the image processor through the through holes, respectively.
